(19) United States
(12) Patent Application Publication
(10) Pub. No.: US 2026/0361135 A1
(43) Pub. Date: Nov. 12, 2026

(54) CURRENT-FED INDUCTIVE WIRELESS CHARGING TRANSMITTER FOR LARGE-SCALE EV IN-MOTION WIRELESS CHARGING INFRASTRUCTURE

(71) Applicants: Mckay Waite, Logan, UT (US); Regan A. Zane, Hyde Park, UT (US); Hongjie Wang, North Logan, UT (US)

(72) Inventors: Mckay Waite, Logan, UT (US); Regan A. Zane, Hyde Park, UT (US); Hongjie Wang, North Logan, UT (US)

(73) Assignee: Utah State University, Logan, UT (US)

(21) Appl. No.: 19/672,451

(22) Filed: May 8, 2026

Related U.S. Application Data
(60) Provisional application No. 63/802,447, filed on May 8, 2025.

(51) Int. Cl. H02J 50/12; B60L 53/122; B60L 53/62; H02J 50/40

(52) U.S. Cl. CPC H02J 50/12; B60L 53/122; B60L 53/62; H02J 50/40

(57) ABSTRACT

A wireless power transfer (“WPT”) transmitter includes a transmitter coil configured to provide power wirelessly to a load and includes a series capacitor in series with transmitter coil. The transmitter coil and series capacitor have a first and second terminal. The WPT transmitter includes a parallel capacitor and a parallel inductor connected between the first and second terminals and a switching section with switches configured in a rectifier configuration with an output connected to the first and second terminals. The WPT transmitter includes an input inductor connected to the switching section and an input capacitor connected in parallel with input inductor and switching section at input terminals connected to a current source that provides a constant current to the WPT transmitter. The WPT transmitter includes a controller configured to regulate switches in the switching section to maintain a constant current in the transmitter coil.

### CROSS-REFERENCES TO RELATED APPLICATIONS

This application claims the benefit of U.S. Provisional Patent Application No. 63/802,447 entitled “CURRENT-FED INDUCTIVE WIRELESS CHARGING TRANSMITTER FOR LARGE-SCALE EV IN-MOTION WIRELESS CHARGING INFRASTRUCTURE” and filed on May 8, 2025, for Mckay Waite et al., which is incorporated herein by reference.

### GOVERNMENT CLAUSE

This invention was made with government support under 2239169 and EEC1941524 awarded by the National Science Foundation. The government has certain rights in the invention.

### FIELD

This invention relates to wireless power transfer and more particularly relates to a current-fed charging transmitter for in-motion electric vehicles.

### BACKGROUND

According to a recent study, global electric vehicle (“EV”) sales supremacy will arrive by 2030, three years earlier than previously expected. As EV adoption accelerates, charging infrastructure is expected to be the main limiting factor over the next decade and beyond. Most efforts to improve EV charging technology have been put into charger development, including wired and wireless chargers, to push for higher power and efficiency, new power converter topologies, and the application of new semiconductor devices. However, another problem, which has not been adequately addressed, is how to distribute power to the input terminals of the chargers, especially in large-scale scenarios.

The existing power distribution approaches are based on low-voltage DC distribution or grid-frequency ac distribution and focus predominantly on small-scale or pilot application scenarios. These existing system architectures for EV charging cannot realize large-scale power distribution to the charger inputs with acceptable performance due to voltage drop in cables, complexity in system wiring, and cost.

One example of a large-scale power distribution network is a dynamic inductive wireless power transfer (“DWPT”) system designed to charge EVs while the vehicles move on a roadway. DWPT systems can help lower the cost of EVs by reducing the size of the battery, the most expensive part in an EV, and address EV range and charging anxiety. Additionally, through use of bidirectional power converters, vehicle-to-grid (V2G) technology could be implemented in DWPT systems. Benefits of V2G technology have been shown in stationary plug-in and wireless charging applications such as helping to stabilize the grid and promoting large-scale integration of renewable energy sources. Large-scale implementation of DWPT networks also include complications regarding system construction, cost, and efficient power distribution to terminals of the power transmitting units.

To address challenges in power distribution and improve system efficiency with reduced cost for the large-scale EV in-motion wireless charging infrastructure, a new dynamic inductive wireless power transfer system with a power transmitter module has been presented in recent documents. The documents showed a novel system architecture for distributing power to the charger inputs in large-scale in-motion charging applications with focusing on system architecture and presenting a new set of transmitter topologies that can be used in the proposed system architecture. The direct current (“DC”) power distribution architecture, where transmitters are series connected as shown in FIG. 1, achieves power distribution to numerous transmitters in large-scale EV in-motion wireless charging systems with high efficiency, high reliability, and low-cost.

In one reference, the authors presented modeling and comparative analysis of different system architectures for large-scale EV in-motion wireless charging systems and validated the benefits of the patented power distribution architecture through modeling and analysis. The key contribution of this paper is the proposal of a new current-fed wireless charging transmitter that is capable of no-load operation, has load independent transmitter coil current, has low component stress, and has high tolerance to component mistuning, which improves the system reliability and performance. Furthermore, the new charging transmitter can be designed to be capable of either unidirectional or bidirectional power flow.

### SUMMARY

A wireless power transfer (“WPT”) transmitter includes a transmitter coil with a transmitter inductance L_{T}, where the transmitter coil is configured to provide power wirelessly to a receiver coil feeding a load. The WPT transmitter includes a series capacitor C_{S} connected in series with transmitter coil. The transmitter coil and series capacitor C_{S} have a first terminal and a second terminal. The WPT transmitter includes a parallel capacitor C_{P} connected between the first and second terminals and a parallel inductor L_{P} connected between the first and second terminals. The WPT transmitter includes a switching section with switches configured in a rectifier configuration and with an output connected to the first and second terminals. The WPT transmitter includes an input inductor Lᵢₙ connected in series with an input of the switching section and an input capacitor Cᵢₙ connected in parallel with input inductor Lᵢₙ and the switching section. A terminal connecting the input capacitor Cᵢₙ to the input inductor Lᵢₙ is a first input terminal and a terminal of the switching section is a second input terminal and the first and second input terminals are input terminals where the input terminals are configured to be connected to a current source that provides a constant current to the WPT transmitter. The WPT transmitter includes a controller configured to regulate switches in the switching section to maintain a constant current in the transmitter coil.

A system for wireless power transfer includes a constant current source and a WPT transmitter. The WPT transmitter includes a transmitter coil with a transmitter inductance L_{T}, where the transmitter coil is configured to provide power wirelessly to a receiver coil feeding a load. The WPT transmitter includes a series capacitor C_{S} connected in series with transmitter coil. The transmitter coil and series capacitor C_{S} include a first terminal and a second terminal. The WPT transmitter includes a parallel capacitor C_{P} connected between the first and second terminals, a parallel inductor L_{P} connected between the first and second terminals, and a switching section with switches configured in a rectifier configuration and with an output connected to the first and second terminals. The WPT transmitter includes an input inductor Lᵢₙ connected in series with an input of the switching section and an input capacitor Cᵢₙ connected in parallel with input inductor Lᵢₙ and the switching section. A terminal connecting the input capacitor Cᵢₙ to the input inductor Lᵢₙ is a first input terminal and a terminal of the switching section is a second input terminal. The first and second input terminals are input terminals and the input terminals are configured to be connected to a current source that provides a constant current to the WPT transmitter. The WPT transmitter includes a controller configured to regulate switches in the switching section to maintain a constant current in the transmitter coil.

Another WPT transmitter includes a transmitter coil with a transmitter inductance L_{T}, where the transmitter coil is configured to provide power wirelessly to a receiver coil feeding a load that include components an electric vehicle, and a series capacitor C_{S} connected in series with transmitter coil. The transmitter coil and series capacitor C_{S} include a first terminal and a second terminal. The WPT transmitter includes a parallel capacitor C_{P} connected between the first and second terminals, a parallel inductor L_{P} connected between the first and second terminals, and a switching section with switches configured in a current-fed H-bridge rectifier configuration and with an output connected to the first and second terminals. The WPT transmitter includes an input inductor Lᵢₙ connected in series with an input of the switching section and an input capacitor Cᵢₙ connected in parallel with input inductor Lᵢₙ, and the switching section. A terminal connecting the input capacitor Cin to the input inductor Lin is a first input terminal and a terminal of the switching section is a second input terminal. The first and second input terminals are input terminals and the input terminals are configured to be connected to a current source that provides a constant current to the WPT transmitter. The WPT transmitter includes a controller configured to vary a phase shift α of the switches in the switching section to maintain a constant current in the transmitter coil.

The present disclosure is not limited by the examples provided in this summary section, and the above and other methods, systems, devices, and products will be provided herein and/or be apparent to those with skill in the art based on the inventive concepts provided herein.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system of an architecture for large-scale electric vehicle in-motion charging, according to various embodiments;

FIG. 2 is a circuit diagram illustrating a circuit topology of a proposed current-fed charging transmitter, according to various embodiments;

FIG. 3 is a phase shift modulation diagram of the proposed current-fed charging transmitter, according to various embodiments;

FIG. 4 depicts a simulation model of a 1-kilowatt (“kW”) current-fed transmitter design, according to various embodiments;

FIG. 5 illustrates system results of an electric vehicle driving over a 1 kW wireless current-fed transmitter, according to various embodiments;

FIG. 6 illustrates steady-state waveforms at different operating points: (a) 1 kW power transfer, and (b) no-load operation, according to various embodiments; and

FIG. 7 illustrates steady-state waveforms at different operating points with mistuning: (a) 120 kW with coil self-inductance L_{T} 20% higher and parallel compensation inductance Lₚ 10% higher, (b) No-load with coil self-inductance L_{T} 20% higher and parallel compensation inductance Lₚ 10% higher, (c) 120 kW with coil self-inductance L_{T} 20% lower and parallel compensation inductance Lₚ 10% lower, (d) No-load with coil self-inductance L_{T} 20% lower and parallel compensation inductance Lp 10% lower.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the invention may be combined in any suitable manner in one or more embodiments. In the following description, numerous specific details are provided, such as examples of programmable hardware devices, software modules, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “controller,” “circuit,” “module,” “system,” or the like. Furthermore, aspects of the present invention may take the form of a computer program product embodied in one or more computer readable medium(s) having program code embodied thereon.

Many of the functional units described in this specification have been labeled as modules or controllers, in order to more particularly emphasize their implementation independence. For example, a module or controller may be implemented as a hardware circuit comprising custom very large scale integrated (“VLSI”) circuits or gate arrays, off-the-shelf semiconductors such as logic chips, transistors, or other discrete components. A module or controller may also be implemented in programmable hardware devices such as a field programmable gate array (“FPGA”), programmable array logic, programmable logic devices or the like.

Modules or controllers may also be implemented in software for execution by various types of processors. An identified module or controller with program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module or the controller.

Indeed, a module or controller with program code may be a single instruction, or many instructions, and may even be distributed over several different code segments, among different programs, and across several memory devices. Similarly, operational data may be identified and illustrated herein within modules or controllers, and may be embodied in any suitable form and organized within any suitable type of data structure. The operational data may be collected as a single data set, or may be distributed over different locations including over different storage devices, and may exist, at least partially, merely as electronic signals on a system or network. Where a module or controllers or portions of a module or controllers are implemented in software, the program code may be stored and/or propagated on in one or more computer readable medium(s).

Furthermore, embodiments may take the form of a program product embodied in one or more computer readable storage devices storing machine readable code, computer readable code, and/or program code, referred hereafter as code. The storage devices, in some embodiments, are tangible, non-transitory, and/or non-transmission.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

The description of elements in each figure may refer to elements of proceeding figures. Like numbers refer to like elements in all figures, including alternate embodiments of like elements.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” or “A, B, or C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

A wireless power transfer (“WPT”) transmitter includes a transmitter coil with a transmitter inductance L_{T}, where the transmitter coil is configured to provide power wirelessly to a receiver coil feeding a load. The WPT transmitter includes a series capacitor C_{S} connected in series with transmitter coil. The transmitter coil and series capacitor C_{S} have a first terminal and a second terminal. The WPT transmitter includes a parallel capacitor C_{P} connected between the first and second terminals and a parallel inductor L_{P} connected between the first and second terminals. The WPT transmitter includes a switching section with switches configured in a rectifier configuration and with an output connected to the first and second terminals. The WPT transmitter includes an input inductor Lᵢₙ connected in series with an input of the switching section and an input capacitor Cᵢₙ connected in parallel with input inductor Lᵢₙ and the switching section. A terminal connecting the input capacitor Cᵢₙ to the input inductor Lᵢₙ is a first input terminal and a terminal of the switching section is a second input terminal and the first and second input terminals are input terminals where the input terminals are configured to be connected to a current source that provides a constant current to the WPT transmitter. The WPT transmitter includes a controller configured to regulate switches in the switching section to maintain a constant current in the transmitter coil.

In some embodiments, the switching section is configured in a current-fed H-bridge rectifier configuration. In other embodiments, the controller is configured to maintain the constant current in the transmitter coil by varying a phase shift α of the switches of the switching section. In other embodiments, the constant current in the transmitter coil is related to the phase shift α by:

$${i}_{{T}_{rms}} = \frac{2 \sqrt{2} {I}_{in} sin ( \frac{α}{2} )}{π} ,$$

where i_{T_rms} is a root-mean-square (“rms”) value of a current in the transmitter coil, Iᵢₙ is the constant current from the current source, and a is the phase shift of the switches of the switching section.

In some embodiments, the load includes a battery and/or a motor of an electric vehicle. In other embodiments, as the electric vehicle moves over the transmitter coil, the load varies from a no-load state to a full load state to the no-load state. In other embodiments, the controller is configured to close the switches of the switching section forming a short circuit across the switches in response to the load being in a no-load state. In other embodiments, voltage across the output of the switching section varies from a low value while the switches are closed in a short circuit state to at or near a maximum value as the load varies from the no-load state to the full load state. In other embodiments, the WPT transmitter is mounted in a roadway configured for electric vehicles to pass over the WPT transmitter. In other embodiments, the WPT transmitter is one of a plurality of WPT transmitters mounted in a roadway in a direction of travel of electric vehicles, and the plurality of WPT transmitters are connected in series with each other and in series with the current source. In other embodiments, the switches of the WPT transmitter are configured to be controlled using sensing within the WPT transmitter.

A system for wireless power transfer includes a constant current source and a WPT transmitter. The WPT transmitter includes a transmitter coil with a transmitter inductance L_{T}, where the transmitter coil is configured to provide power wirelessly to a receiver coil feeding a load. The WPT transmitter includes a series capacitor C_{S} connected in series with transmitter coil. The transmitter coil and series capacitor C_{S} include a first terminal and a second terminal. The WPT transmitter includes a parallel capacitor C_{P} connected between the first and second terminals, a parallel inductor L_{P} connected between the first and second terminals, and a switching section with switches configured in a rectifier configuration and with an output connected to the first and second terminals. The WPT transmitter includes an input inductor Lᵢₙ, connected in series with an input of the switching section and an input capacitor Cᵢₙ connected in parallel with input inductor Lᵢₙ and the switching section. A terminal connecting the input capacitor Cᵢₙ to the input inductor Lᵢₙ, is a first input terminal and a terminal of the switching section is a second input terminal. The first and second input terminals are input terminals and the input terminals are configured to be connected to a current source that provides a constant current to the WPT transmitter. The WPT transmitter includes a controller configured to regulate switches in the switching section to maintain a constant current in the transmitter coil.

In some embodiments, the WPT transmitter is one of a plurality of WPT transmitters connected in series with each other and in series with the constant current source. In other embodiments, each of the plurality of WPT transmitters are separated with a trunk cable connected between each of the plurality of WPT transmitters. In other embodiments, the plurality of WPT transmitters are each mounted in a roadway and are configured to provide power to a moving electric vehicle. In other embodiments, each of the plurality of WPT transmitters are separated by a same distance. In other embodiments, each of the plurality of WPT transmitters is configured to provide power to a moving electric vehicle and is configured to vary from a no-load state to a full load state to the no-load state as the electric vehicle moves over the WPT transmitter.

Another WPT transmitter includes a transmitter coil with a transmitter inductance L_{T}, where the transmitter coil is configured to provide power wirelessly to a receiver coil feeding a load that include components an electric vehicle, and a series capacitor C_{S} connected in series with transmitter coil. The transmitter coil and series capacitor C_{S} include a first terminal and a second terminal. The WPT transmitter includes a parallel capacitor C_{P} connected between the first and second terminals, a parallel inductor L_{P} connected between the first and second terminals, and a switching section with switches configured in a current-fed H-bridge rectifier configuration and with an output connected to the first and second terminals. The WPT transmitter includes an input inductor Lᵢₙ connected in series with an input of the switching section and an input capacitor Cᵢₙ connected in parallel with input inductor Lᵢₙ and the switching section. A terminal connecting the input capacitor Cin to the input inductor Lin is a first input terminal and a terminal of the switching section is a second input terminal. The first and second input terminals are input terminals and the input terminals are configured to be connected to a current source that provides a constant current to the WPT transmitter. The WPT transmitter includes a controller configured to vary a phase shift α of the switches in the switching section to maintain a constant current in the transmitter coil.

In some embodiments, the constant current in the transmitter coil is related to the phase shift α by:

$${i}_{{T}_{rms}} = \frac{2 \sqrt{2} {I}_{in} sin ( \frac{α}{2} )}{π} ,$$

where i_{T_rms} is a root-mean-square (“rms”) value of a current in the transmitter coil, Iᵢₙ is the constant current from the current source, and a is the phase shift of the switches of the switching section. In other embodiments, the load varies from a no-load state to a full load state to the no-load state as the electric vehicle moves across the transmitter coil.

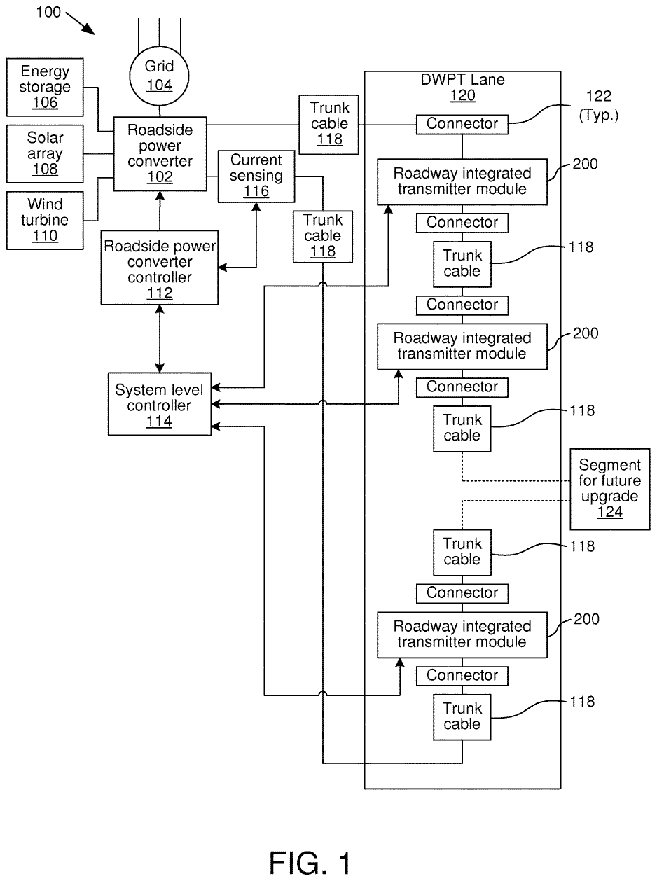

FIG. 1 is a schematic block diagram illustrating one embodiment of a system 100 of an architecture for large-scale electric vehicle in-motion charging, according to various embodiments. As shown in FIG. 1, a DC power distribution system architecture has electric vehicle (“EV”) in-motion wireless charging transmitter units, depicted as roadway integrated transmitter modules 200 (each of which may be described herein as a wireless power transfer (“WPT”) transmitter 200), connected in series through trunk cables 118 powered by a roadside power converter 102 with regulated distribution current. The architecture of the system 100 allows a relatively low current to flow through the trunk cables 118, which, in some embodiments, results in lower cable losses and allows the use of thinner trunk cables 118. The large-scale EV in-motion wireless charging system 100 is expected to be pavement integrated with the roadway, depicted as a dynamic inductive wireless power transfer (“DWPT”) lane 120. In some embodiments, the WPT transmitters 200 are separated by a same distance.

For a single-lane scenario, in some embodiments, the roadway integrated transmitter modules 200 are located in the forward current path and the return current cable sits at ground potential without any cuts, as seen in FIG. 1. For a two-lane scenario, in some embodiments, one lane is on the forward current path while the other lane is on the return current path so that the distribution cables (trunk cables 118) can be fully utilized. In the system 100, roadway integrated transmitter modules 200 include only two connectors 122 for the series connection. The roadway integrate transmitter modules 200 are fed from a distribution current regulated by the roadside power converter 102. The roadside power converter 102, in some embodiments, is the interface to utility grid 104, renewable energy sources, such as a solar array 108 and/or a wind turbine 110, and energy storage 106, and is capable of eliminating the peak power demand to utility grid caused by the in-motion charging load. With these features and benefits, in some embodiments, the system 100 can achieve reduced system cost and complexity of construction.

In some embodiments, a direct current (“DC”) constant input current driven wireless power transmitter may be used for a unique power distribution system. The DC constant input current driven transmitter design includes a LC filter at an input to the transmitter, a current-fed H-bridge, and a parallel compensation network for a transmitter coil self-inductance. Various hardware sharing configurations may be used for reducing system cost.

The system 100, in some embodiments, includes a roadside power converter controller 112 configured to control the roadside power converter 102. In some embodiments, the system 100 includes current sensing 116 on the trunk cables 118, which is used by the roadside power converter controller 112 to control switches in the roadside power converter 102 to regulate current so that the roadside power converter 102 operates as a constant current source. In some embodiments, overall control of the system 100 is by a system level controller 114. The system level controller 114, in some embodiments, controls power up, power down, increasing power levels, decreasing power levels, and other administrative functions. In some embodiments, the system level controller 114 is in communication with other computing devices over a network. In other embodiments, the system 100 does not include the system level controller 114 and some or all of the functions mentioned in conjunction with the system level controller 114 are in the roadside power converter 112. In other embodiments, the system level controller 114 is remote from the components of the system 100 and controls the system 100 remotely.

In some embodiments, the roadway integrated transmitter modules 200 are connected to the trunk cables 118 using connectors 122. In some embodiments, the connectors 122 are designed for easy installation and removal of the roadway integrated transmitter modules 200, which may be accessible through covers in the roadway 120.

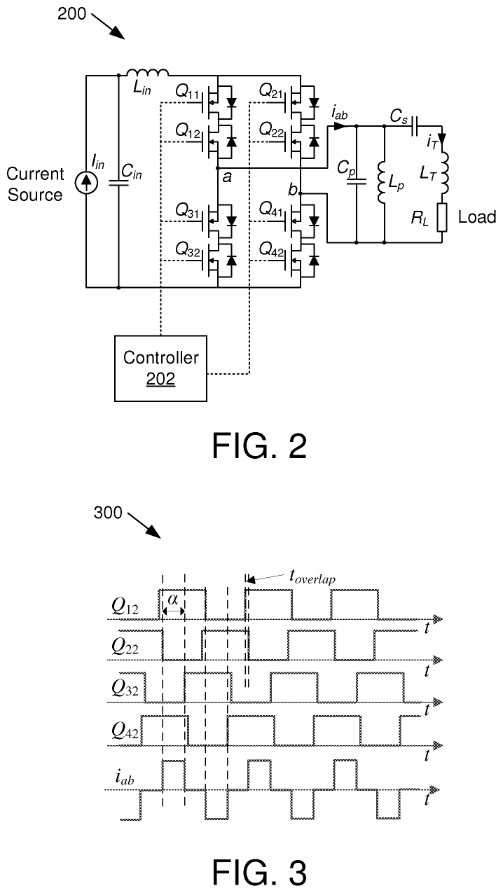

FIG. 2 is a circuit diagram illustrating a circuit topology of a proposed current-fed charging transmitter 200, according to various embodiments. This new WPT transmitter 200, in some embodiments, includes single-stage current-fed H-bridge with capacitor-inductor-capacitor (“CLC”) compensation transmitter topology, as shown in FIG. 2. The WPT transmitter 200, in some embodiments, is designed for large-scale EV in-motion wireless charging to achieve load-independent transmitter coil current, high tolerance on variation of components' value, and misalignment. For the WPT transmitter 200 of FIG. 2, Iᵢₙ is a current source, that in some embodiments, is the system distribution current regulated by the roadside power converter 102. The WPT transmitter 200 includes input capacitor Cᵢₙ and input inductor Lᵢₙ, that, in some embodiments, function together as an input filter to achieve an expected input voltage ripple.

A switching section includes switches, which are depicted as metal-oxide-semiconductor field-effect transistors (“MOSFETs”) labeled Q₁₁-Q₄₂, which are part of a current-fed H-bridge to generate square current waveform at the H-bridge output, labeled as terminals a and b. IN some embodiments, terminals a and b are described as first and second terminals. The WPT transmitter 200 includes a transmitter coil with an inductance L_{T} with a transmitter coil current i_{T}. The WPT transmitter 200 includes a proposed compensation network with a parallel capacitor Cₚ, a parallel inductor Lₚ, and a series capacitor C_{S}. L_{T} represents the transmitter coil self-inductance, and R_{L} is the reflected load resistance. In various embodiments, the load is a moving EV. In other embodiments, the load includes a battery and/or a motor of the EV. The WPT transmitter 200 of FIG. 2 includes eight MOSFETs instead of 4 MOSFETs that a typical voltage-fed H-bridge includes. While the switches of the switching section of the WPT transmitter 200 are depicted as MOSFETs, in other embodiments, other semiconductor switches are used. In some embodiments, even with more semiconductor devices, the system cost will still be lower due to the benefits of using low-current rated trunk cables 118 and much-reduced construction complexity, especially for largescale applications. In some embodiments, four out of the eight MOSFETs shown in FIG. 2 are replaced by diodes where a bi-directional operation is not required to reduce cost and complexity.

The embodiments described herein include a new transmitter topology design and corresponding analysis, so the load has been assumed to be a resistive load reflected from the receiver side. In embodiments described herein, phase shift modulation control is used and is implemented via a controller 202. In some embodiments, all or a portion of the controller 202 is implemented using hardware circuits. In other embodiments, all or a portion of the controller 202 is implemented using a programmable hardware device. In other embodiments, the controller 202 is implemented using executable code stored on computer readable storage media and the controller 202 includes a processor. One of skill in the art will recognize other ways to implement the controller 202.

Applying fundamental harmonics approximation analysis to the proposed transmitter topology shown in FIG. 2, the root mean square (rms) value of the transmitter coil current i_{T_rms} can be derived as:

$${i}_{{T}_{rms}} = \frac{2 \sqrt{2} {I}_{in} sin ( \frac{α}{2} )}{π} \frac{{ω}^{2} {L}_{p} {C}_{s}}{\sqrt{X}} , where , \qquad ( 1 )$$

$$X = {( 1 - {ω}^{2} ( {L}_{T} {C}_{s} + {L}_{p} {C}_{p} + {C}_{s} {L}_{p} ) + {ω}^{4} {L}_{T} {C}_{s} {L}_{p} {C}_{p} )}^{2} + {( ω {R}_{L} ( {C}_{s} - {ω}^{2} {C}_{s} {L}_{p} {C}_{p} ) )}^{2} \qquad ( 2 )$$

In equations (1) and (2), Ln is the distribution current is from a constant current source, such as the roadside power converter 102. Lₚ, Cₚ, and Cₛ are passive components of the compensation network in this high-order compensation circuit design, L_{T} is the transmitter coil self-inductance, and a is the phase shift of the current-fed H-bridge ranging from 0° to 180°.

In some embodiments, the controller 202 is configured to regulate the switches Q₁₁-Q₄₂ in the switching section to maintain a constant current in the transmitter coil. In some embodiments, the controller 202 is configured to maintain the constant current in the transmitter coil by varying a phase shift α of the switches of the switching section. The phase shift α is depicted in FIG. 3. In some embodiments, the controller 202 is configured to vary the phase shift α using equation (1).

FIG. 3 is a phase shift modulation diagram 300 of the proposed current-fed charging transmitter 200, according to various embodiments. As shown in FIG. 3, the phase shift α is defined as the phase difference between the top two and bottom two switches. Additionally, there is an overlapping time between the top two switches and between the bottom two switches in each leg, which is different from the voltage-fed H-bridge. The transmitter H-bridge is current-fed, so the overlapping time prevents the occurrence of an open circuit during the switching cycle. In some embodiments, an open circuit could cause damage to the switches fed by a constant current source. In FIG. 3, Q₁₁, Q₂₁, Q₃₁, and Q₄₁ are controlled to behave as diodes.

The two resonant frequencies in the CLC compensation circuit are defined as

$${f}_{o 1} = \frac{1}{2 π \sqrt{{L}_{p} {C}_{p}}} , \qquad ( 3 )$$

$${f}_{o 2} = \frac{1}{2 π \sqrt{{L}_{T} {C}_{s}}} , \qquad ( 4 )$$

When fₒ₁=fₛ, the parallel combination of Lₚ and Cₚ appears as an open circuit at the fundamental switching frequency. Similarly, when fₒ₂=fₛ, the series combination of L_{T} and Cₛ appears as a short circuit at the fundamental switching frequency. When fₒ₁=fₒ₂=fₛ, from equations (1) and (2), the transmitter coil current i_{T_rms} can be expressed as:

$${i}_{{T}_{rms}} = \frac{2 \sqrt{2} {I}_{in} sin ( \frac{α}{2} )}{π} . \qquad ( 5 )$$

From equation (5), it can be seen that the transmitter coil rms current i_{Trms} is independent of load, which means the transmitter side control effort is minimal and could allow the receiver side to control power transfer without real-time communication with the transmitter side. Thus, the switches Q₁₁-Q₄₂ of the WPT transmitter 200 are configured to be controlled using sensing within the WPT transmitter 200. This feature can significantly increase safety, reliability, and robustness of the system 100.

With the transmitter coil rms current shown in equation (5), the voltage and current of the components in the compensation circuit can be derived as:

$${V}_{{C}_{{s}_{peak}}} = \sqrt{2} {i}_{{T}_{rms}} ω {L}_{T} = \frac{\sqrt{2} {i}_{{T}_{rms}}}{ω {C}_{s}} . \qquad ( 6 )$$

$${V}_{{C}_{{p}_{peak}}} = \sqrt{2} {i}_{{T}_{rms}} {R}_{L} = \frac{\sqrt{2} P}{{i}_{{T}_{rms}}} , \qquad ( 7 )$$

$${i}_{{L}_{{p}_{rms}}} = \frac{{i}_{{T}_{rms}} {R}_{L}}{ω {L}_{p}} = \frac{P}{ω {L}_{p} {i}_{{T}_{rms}}} , \qquad ( 8 )$$

where P is the power transferred to the receiver side. From equation (6), it can be seen that the series compensation capacitor voltage is independent from the load. However, not all voltages and currents in the system are independent of load. From equations (7) and (8), it can be seen that the

$${V}_{{C}_{{p}_{peak}}}$$

and

$${i}_{{L}_{prms}}$$

are proportional to the transferred power P.

The value of the voltage V_{C}_{ₚ} across the parallel capacitor C_{P} is of particular interest in this topology because V_{C}_{ₚ} is the voltage that appears across the devices in the H-bridge. Therefore, to prevent device damage, the selected switching devices must have a sufficient voltage rating to withstand

$${V}_{{C}_{{p}_{peak}}} .$$

Additionally, the value

$${i}_{{L}_{prms}} ,$$

which is the current through the parallel inductor L_{P} allows for calculation of the power dissipated in the equivalent series resistance (“ESR”) of the parallel inductor Lₚ.

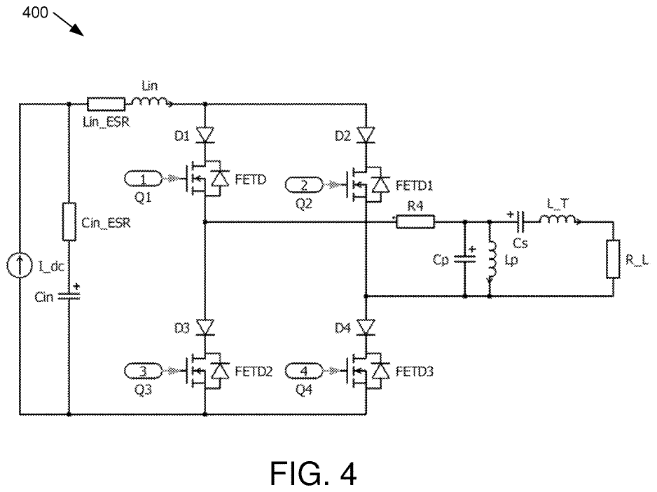

FIG. 4 depicts a simulation model 400 of a 1-kilowatt (“kW”) current-fed transmitter design, according to various embodiments. A Matlab/PLECS® simulation model of a 1 kW current-fed transmitter design for EV in-motion wireless charging has been developed, as shown in FIG. 4. The ESR is assumed to be 10 1 milliohm (“mΩ”) for both the input filter capacitor and inductor. The resistor R₄ is a 1 mΩ sensing resistor for the H-bridge output current (i_{ab}) sensing, and R_{L} is the reflected load resistance. In the simulations, a variable load resistance profile is used to emulate an EV driving through the transmitter coil with 1 kW rated charging power. The parameters of the designed 1 kW current-fed transmitter are tabulated in Table I. The transmitter coil self-inductance is from an Ansys® simulation of the coil design.

TABLE 1
PARAMETERS OF THE DESIGNED 1
KW CURRENT-FED TRANSMITTER

| Parameter | Theoretical Value | |
|---|---|---|
| Power rating P | 1 | kW |
| Switching frequency fₛ | 85 | kHz |
| Distribution current I_{dc} | 5 | A |
| Transmitter coil rms current i_{Trms} | 4.43 | A |
| Transmitter coil self-inductance L_{T} | 23.2 | μH |
| Series compensation capacitor Cₛ | 0.15 | μF |
| Parallel compensation inductor Lₚ | 56.89 | μH |
| Parallel compensation capacitor Cₚ | 0.06 | μF |
| Input filter capacitor Cᵢₙ | 20 | μF |
| Input filter inductor Lᵢₙ | 500 | μH |

| | |
|---|---|
| Phase shift angle α | 160° |

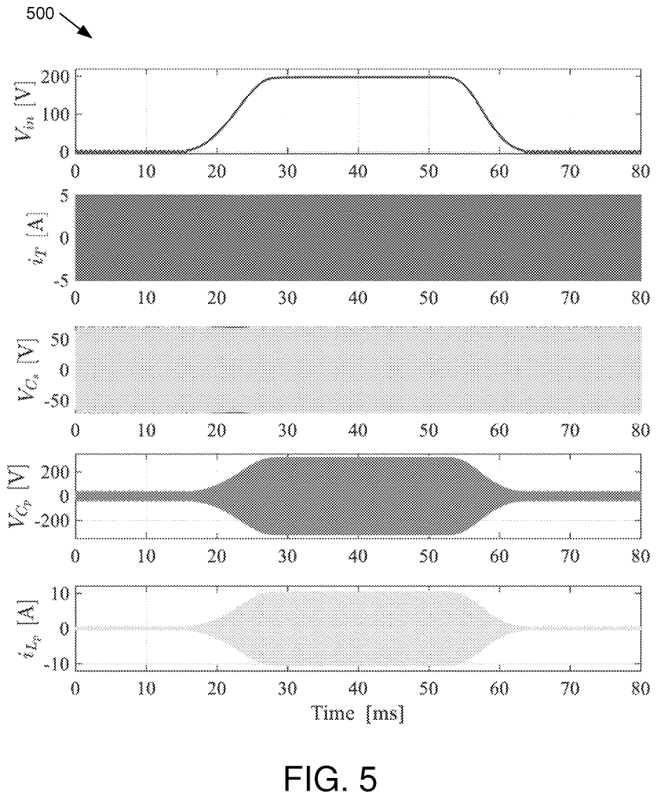

FIG. 5 illustrates system results 500 of an electric vehicle driving over a 1 kW wireless current-fed transmitter, according to various embodiments. As an EV drives over a WPT transmitter 200, load of the EV on the WPT transmitter 200 varies from a no-load state to a full load state to the no-load state. The no-load state, as used herein, is when the EV is far enough from the WPT transmitter 200 so no power is transmitted from the WPT transmitter 200 to the EV. Note that due to some losses due to ESR and other factors, in some embodiments, at least a small portion of power is consumed in the WPT transmitter 200. As used herein, the full load state occurs when the EV is directly over the WPT transmitter 200. In some embodiments, the amount of power transmitted to the EV when the EV is directly over the WPT transmitter 200 is lower than a maximum power that the WPT transmitter 200 is capable of supplying.

From FIG. 5, it can be seen that the input voltage Vₙ varies proportionally to the power transmitted as the EV drives through the transmitter coil. Similarly, the parallel compensation capacitor voltage V_{C}_{ₚ} and the parallel compensation inductor current i_{L}_{ₚ} are proportional to the power that is being transferred.

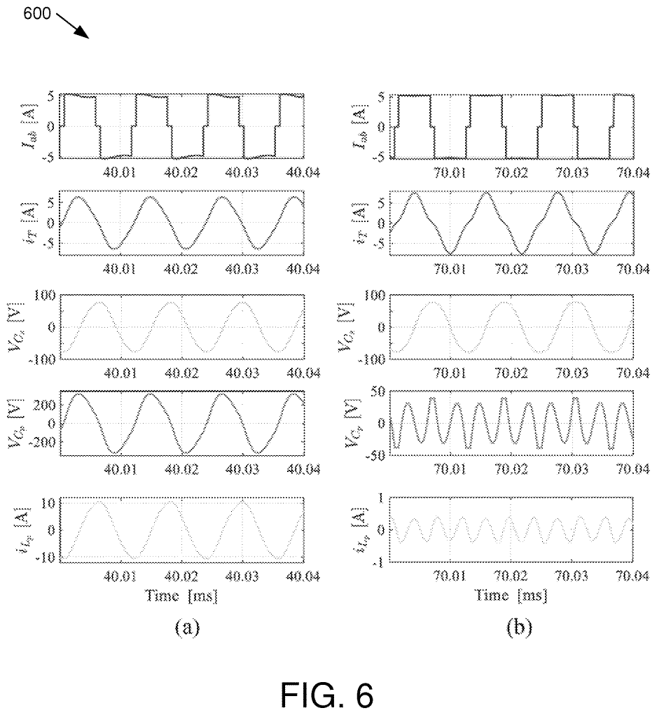

The transmitter coil current i_{T} and series compensation capacitor voltage V_{C}_{ₛ} remain constant throughout the simulation showing they are independent from the load. The steady state waveforms 600 of the proposed WPT transmitter 200 at different operating points are shown in FIG. 6, where FIG. 6(a) is for the 1 kW power transfer operation and FIG. 6(b) is for the no load operation. Some distortion appears in the i_{T} no-load waveform due to the presence of switching harmonics. To evaluate the effect of the harmonics on i_{T_rms}, the percent deviation (“PD”) can be examined. The PD is calculated by.

$$PD = 100 \cdot \frac{{i}_{{T}_{{rms}_{actual}}} - {i}_{{T}_{rms}}}{{i}_{{T}_{rms}}} , \qquad ( 9 )$$

where i_{T_rms} is the theoretical value of the transmitter pad rms current as given by equation (5) and i_{t_rms_actual} is the actual transmitter pad rms current when harmonics are taken into account. The value for i_{t_rms_actual} is easily obtained through a simulation platform like PLECS. At the no-load operating point, i_{T_rms_actual}=4.51 A. The PD is calculated to be 1.8% using equations (5) and (9). This small PD shows that the transmitter coil rms current is constant regardless of the power level. The results in FIG. 5 and FIG. 6 validate that the proposed new current-fed WPT transmitter 200 has load independent coil current and operates without the receiver side.

In some embodiments, as the electric vehicle moves over the transmitter coil, the load varies from a no-load state to a full load state to the no-load state. In various embodiments, the controller 202 is configured to close the switches Q₁₁-Q₄₂ of the switching section forming a short circuit across the switches in response to the load being in a no-load state. In some embodiments, the controller 202 closes switches Q₁₁, Q₁₂, Q₃₁, and Q₃₂ for the no-load condition. In other embodiments, the controller 202 closes switches Q₂₁, Q₂₂, Q₄₁, and Q₄₂ for the no-load condition. In other embodiments, the controller 202 closes all of the switches Q₁₁-Q₄₂ for the no-load condition. In various embodiments, as the EV moves over the transmitter coil, voltage across the output of the switching section varies from a low value while the switches Q₁₁-Q₄₂ are closed in a short circuit state to at or near a maximum value as the load varies from the no-load state to the full load state. In some embodiments, the maximum value of the voltage across the output of the switching section is below a maximum allowable voltage when considering voltage ratings of the components of the WPT transmitter 200.

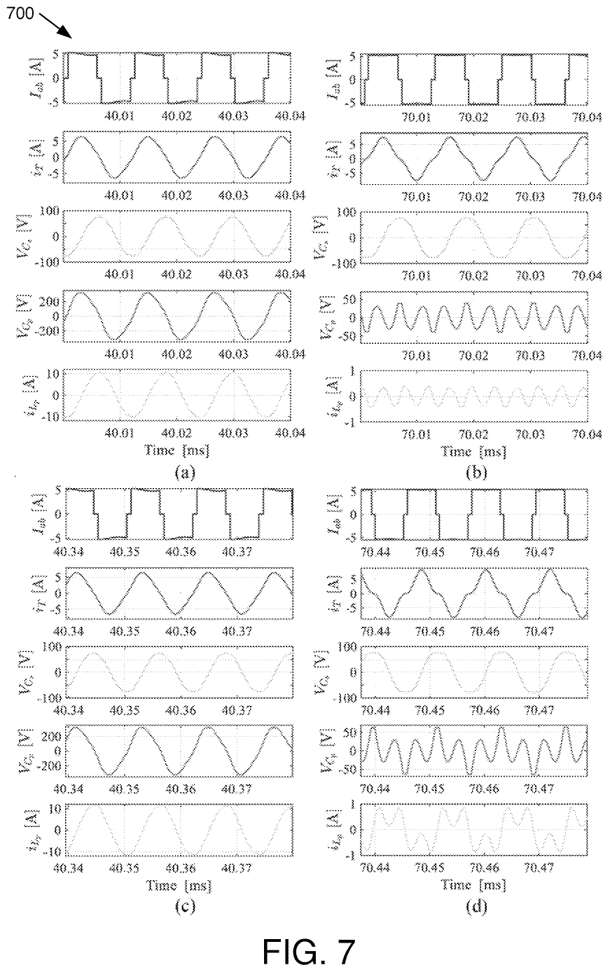

For large-scale EV in-motion wireless charging application, tolerance to mistuning is critical due to nonidealities, manufacturing tolerance, and other factors. Simulation results 700 are provided to validate the high tolerance to mistuning of the proposed current-fed transmitter design, as shown in FIG. 7, where (a) and (b) are the 1 kW and no-load operation results with L_{T} being 20% higher and Lₚ being 10% higher, and (c) and (d) are the 1 kW and no-load operation results with L_{T} being 20% lower and Lₚ being 10% lower. From FIG. 7, it can be seen that the proposed transmitter operates properly and tolerates the mistuning introduced by the large variation in the values of the inductors for both full power and no-load operating conditions. More detail about the mistuning tolerance of the transmitter is given in Table II where PD is listed for the different operating points.

In the considered scenarios at full-power, the biggest PD occurs when L_{T} is 20% lower and Lₚ is 10% lower. In this case, the transmitter coil current i_{t_rms_actual} is load independent with a rms value 1.8% higher than i_{T_rms}, which means the power transferring capability increases by 3.6%, as shown in FIG. 7(c) and FIG. 7(d). The V_{C}_{ₛ}, V_{C}_{ₚ}, and i_{L}_{ₚ} increase consequently, but with acceptable values. This change in power transfer can be easily addressed by reducing the phase shift angle α, and expected operation of the system can be obtained with closed loop control.

TABLE 1I
TRANSMITTING PAID RMS CURRENT
AT DIFFERENT OPERATING POINTS.

| Operating Point | i_{T}_{_{—}}ᵣₘₛ_{_{—}}_{actual} [A] | PD (%) |
|---|---|---|
| No Mistuning (Full Power) | 4.40 | −0.7 |
| No Mistuning (No Load) | 4.51 | 1.8 |
| L_{T} 20% ↑, Lₚ 10% ↑ (Full Power) | 4.40 | −0.7 |
| L_{T} 20% ↑, Lₚ 10% ↑ (No Load) | 4.47 | 0.9 |
| L_{T} 20% ↓, Lₚ 10% ↓ (Full Power) | 4.35 | −1.8 |
| L_{T} 20% ↓, Lₚ 10% ↓ (No Load) | 4.62 | 4.3 |

A new current-fed wireless charging transmitter has been proposed herein as a further development of a patented novel power distribution architecture to achieve improved system efficiency, reliability, and cost for delivering power to the inputs of transmitters in large-scale EV in-motion wireless charging systems. The detailed operation and analysis of the proposed transmitter design has been presented. Matlab/PLECS simulation results from a 1 kW system design have been provided for both tuned and mistuned scenarios to validate the proposed design in terms of the load-independent transmitter coil current operation, high tolerance on the variation of components' value, and robustness to mistuning.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A wireless power transfer (“WPT”) transmitter comprising:
a transmitter coil comprising a transmitter inductance L_{T}, wherein the transmitter coil is configured to provide power wirelessly to a receiver coil feeding a load;
a series capacitor C_{S} connected in series with transmitter coil, the transmitter coil and series capacitor C_{S} comprising a first terminal and a second terminal;
a parallel capacitor C_{P} connected between the first and second terminals;
a parallel inductor L_{P} connected between the first and second terminals;
a switching section comprising switches configured in a rectifier configuration comprising an output connected to the first and second terminals;
an input inductor Lᵢₙ connected in series with an input of the switching section;
an input capacitor Cᵢₙ connected in parallel with input inductor Lᵢₙ and the switching section, wherein a terminal connecting the input capacitor Cᵢₙ to the input inductor Lᵢₙ comprise a first input terminal and a terminal of the switching section comprises a second input terminal, the first and second input terminals comprising input terminals, wherein the input terminals are configured to be connected to a current source that provides a constant current to the WPT transmitter; and
a controller configured to regulate switches in the switching section to maintain a constant current in the transmitter coil.

2. The WPT transmitter of claim 1, wherein the switching section is configured in a current-fed H-bridge rectifier configuration.

3. The WPT transmitter of claim 1, wherein the controller is configured to maintain the constant current in the transmitter coil by varying a phase shift α of the switches of the switching section.

4. The WPT transmitter of claim 3, wherein the constant current in the transmitter coil is related to the phase shift α by:
$${i}_{{T}_{rms}} = \frac{2 \sqrt{2} {{I}_{in}}_{} sin ( \frac{α}{2} )}{π} ,$$
where:
i_{T_rms} is a root-mean-square (“rms”) value of a current in the transmitter coil;
Iᵢₙ is the constant current from the current source; and
α is the phase shift of the switches of the switching section.

5. The WPT transmitter of claim 1, wherein the load comprises a battery and/or a motor of an electric vehicle.

6. The WPT transmitter of claim 5, wherein as the electric vehicle moves over the transmitter coil, the load varies from a no-load state to a full load state to the no-load state.

7. The WPT transmitter of claim 6, wherein the controller is configured to close the switches of the switching section forming a short circuit across the switches in response to the load being in a no-load state.

8. The WPT transmitter of claim 6, wherein voltage across the output of the switching section varies from a low value while the switches are closed in a short circuit state to at or near a maximum value as the load varies from the no-load state to the full load state.

9. The WPT transmitter of claim 1, wherein the WPT transmitter is mounted in a roadway configured for electric vehicles to pass over the WPT transmitter.

10. The WPT transmitter of claim 1, wherein the WPT transmitter is one of a plurality of WPT transmitters mounted in a roadway in a direction of travel of electric vehicles, and wherein the plurality of WPT transmitters are connected in series with each other and in series with the current source.

11. The WPT transmitter of claim 1, wherein the switches of the WPT transmitter are configured to be controlled using sensing within the WPT transmitter.

12. A system comprising:
a constant current source; and
a wireless power transfer (“WPT”) transmitter comprising:
a transmitter coil comprising a transmitter inductance L_{T}, wherein the transmitter coil is configured to provide power wirelessly to a receiver coil feeding a load;
a series capacitor C_{S} connected in series with transmitter coil, the transmitter coil and series capacitor C_{S} comprising a first terminal and a second terminal;
a parallel capacitor C_{P} connected between the first and second terminals;
a parallel inductor L_{P} connected between the first and second terminals;
a switching section comprising switches configured in a rectifier configuration comprising an output connected to the first and second terminals;
an input inductor Lᵢₙ connected in series with an input of the switching section;
an input capacitor Cᵢₙ connected in parallel with input inductor Lᵢₙ and the switching section, wherein a terminal connecting the input capacitor Cᵢₙ to the input inductor Lᵢₙ comprise a first input terminal and a terminal of the switching section comprises a second input terminal, the first and second input terminals comprising input terminals, wherein the input terminals are configured to be connected to a current source that provides a constant current to the WPT transmitter; and
a controller configured to regulate switches in the switching section to maintain a constant current in the transmitter coil.

13. The system of claim 12, wherein the WPT transmitter is one of a plurality of WPT transmitters connected in series with each other and in series with the constant current source.

14. The system of claim 13, wherein each of the plurality of WPT transmitters are separated with a trunk cable connected between each of the plurality of WPT transmitters.

15. The system of claim 13, wherein the plurality of WPT transmitters are each mounted in a roadway and are configured to provide power to a moving electric vehicle.

16. The system of claim 13, wherein each of the plurality of WPT transmitters are separated by a same distance.

17. The system of claim 13, wherein each of the plurality of WPT transmitters is configured to provide power to a moving electric vehicle and is configured to vary from a no-load state to a full load state to the no-load state as the electric vehicle moves over the WPT transmitter.

18. A wireless power transfer (“WPT”) transmitter comprising:
a transmitter coil comprising a transmitter inductance L_{T}, wherein the transmitter coil is configured to provide power wirelessly to a receiver coil feeding a load comprising components an electric vehicle;
a series capacitor C_{S} connected in series with transmitter coil, the transmitter coil and series capacitor C_{S} comprising a first terminal and a second terminal;
a parallel capacitor C_{P} connected between the first and second terminals;
a parallel inductor L_{P} connected between the first and second terminals;
a switching section comprising switches configured in a current-fed H-bridge rectifier configuration comprising an output connected to the first and second terminals;
an input inductor Lᵢₙ connected in series with an input of the switching section;
an input capacitor Cᵢₙ connected in parallel with input inductor Lᵢₙ and the switching section, wherein a terminal connecting the input capacitor Cin to the input inductor Lin comprise a first input terminal and a terminal of the switching section comprises a second input terminal, the first and second input terminals comprising input terminals, wherein the input terminals are configured to be connected to a current source that provides a constant current to the WPT transmitter; and
a controller configured to vary a phase shift α of the switches in the switching section to maintain a constant current in the transmitter coil.

19. The WPT transmitter of claim 18, wherein the constant current in the transmitter coil is related to the phase shift α by:
$${i}_{{T}_{rms}} = \frac{2 \sqrt{2} {{I}_{in}}_{} sin ( \frac{α}{2} )}{π} ,$$
where:
i_{T_rms} is a root-mean-square (“rms”) value of a current in the transmitter coil;
Iᵢₙ is the constant current from the current source; and
α is the phase shift of the switches of the switching section.

20. The WPT transmitter of claim 18, wherein the load varies from a no-load state to a full load state to the no-load state as the electric vehicle moves across the transmitter coil.
